(19) United States
(12) Patent Application Publication
(10) Pub. No.: US 2009/0051714 A1
(43) Pub. Date: Feb. 26, 2009

(54) MOVING IMAGE PLAYBACK APPARATUS AND TONE CORRECTING APPARATUS

(75) Inventor: Kazuto Ohhara, Chiba (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka (JP)

(21) Appl. No.: 12/279,167

(22) PCT Filed: Jan. 25, 2007
(86) PCT No.: PCT/JP2007/051143

§ 371 Date: Aug. 12, 2008

(30) Foreign Application Priority Data
Feb. 13, 2006 (JP) 2006-035484
Jun. 12, 2006 (JP) 2006-162630

(51) Int. Cl. G09G 5/10

(52) U.S. Cl. 345/690

(57) ABSTRACT

A filtering unit filters a moving image decoded by an image decoding unit to reduce noise component. A tone correcting unit corrects tone in accordance with setting of brightness set by a display control unit, utilizing tone characteristic of the moving image. The display control unit detects a signal from an operating unit, and controls brightness of a screen of the display unit. Further, the display control unit controls a switch such that an output of either the filtering unit or the tone correcting unit is input to the display unit.

### TECHNICAL FIELD

The present invention relates to a moving image playback apparatus for playback a moving image and a tone correcting apparatus. Specifically, the present invention relates to a moving image playback apparatus displaying easily viewable moving image even when brightness of a display unit is lowered, as well as to a tone correcting apparatus for correcting tone of the moving image.

### BACKGROUND ART

Recently, moving image playback apparatuses for viewing contents such as moving images on the road have come to be widely used. One major problem of such a portable device is to increase time of continuous use, Though it is possible to make longer the time of continuous use if a battery of large capacity is mounted, weight of the device would be undesirably increased. If the brightness of a display such as an LCD (Liquid Crystal Display) used as a display unit is made darker, the time of continuous use can be increased. In that case, however, the displayed image would be less recognizable, as the screen becomes darker. Proposals have been made to solve such a problem. By way of example, Japanese Patent Laying-Open No. 2004-233441 (Patent Document 1) discloses a technique of providing easily viewable display images by correcting color density of an image to a higher density side when a display screen becomes darker than a prescribed level, using a table having illuminance levels of the display and image density correction values associated beforehand.

### Patent Document 1: Japanese Patent Laying-Open No. 2004-233441

### DISCLOSURE OF THE INVENTION

### Problems to be Solved by the Invention

In these days, however, various types of moving image data including natural images, CGs and animations are distributed. Typically, even moving images of the same type have different characteristics related to tone of images scene by scene. Prior art example described in Patent Document 1 is adapted to use a density correction value adjusted in advance in accordance with the brightness of the display. Uniform correction of the brightness is made regardless of the input moving images. If the screen becomes darker than a prescribed level, correction is made in a direction of higher color density of the image. Therefore, dependent of the characteristics of the moving image to be displayed, such correction leads to saturation of a portion having high density. This impairs subjective quality of the image, making the image less viewable.

The present invention was made to solve such a problem, and its object is to provide a moving image playback apparatus and a tone correcting apparatus that adaptively correct tone in accordance with characteristics of the moving image to be displayed.

### Means for Solving the Problems

According to an aspect, the present invention provides a moving image playback apparatus, including: a display unit for displaying an image; a display control unit for controlling brightness of a screen at the display unit; and a tone adjusting unit for adjusting tone of an input image in correspondence with the brightness of the screen applied from the display control unit; wherein the display control unit controls the tone adjusting unit such that when the brightness of the screen is regulated to be darker than a prescribed brightness, an image adjusted by the tone adjusting unit is displayed on the display unit.

Preferably, an image feature extracting unit extracting a characteristic related to tone of the input image as an image feature, a correction value calculating unit calculating a correction value for a tone value of the image based on the image feature and on a change in the brightness of the screen, and a correcting unit correcting the tone of the input image using the correction value are provided.

Preferably, the correction value calculating unit calculates such a correction value that, among pixels of the input image, the number of pixels of which tone saturates by the correction does not exceed a prescribed value, when frequencies of pixel intensities of the image are distributed within a prescribed range in relation to the characteristic related to tone of the image, and calculates such a correction value that tone in a range satisfying a prescribed condition is compressed, when frequencies of pixel intensities of the image are distributed out of a prescribed range in relation to the characteristic related to tone of the image.

Preferably, the tone adjusting unit includes switching means for selecting and applying to the display unit either the image corrected by the correcting unit or the input image; and the display control unit controls the switching means such that when the brightness of the screen is regulated to be darker than a prescribed brightness, an image corrected by the correcting unit is applied to the display unit.

Preferably, the correction value calculating unit includes means for calculating a correlation value between continuous, previous and succeeding frames of an input moving image and for outputting, when correlation of histogram is high, a correction value for the preceding frame.

Preferably, the input image consists of luminance component and chrominance component; and the correction value calculating unit includes means for changing a correction value for the luminance component in accordance with histogram distribution of the chrominance component.

Preferably, the apparatus further includes a filtering unit for enhancing sharpness of the input image, as the brightness of the screen applied from the display control unit becomes darker.

According to another aspect, the present invention provides a tone correcting apparatus for correcting tone of a moving image to be displayed on a display apparatus, including an image feature extracting unit extracting a characteristic related to tone of an image as one frame of the moving image as an image feature; a frame correlation calculating unit calculating degree of correlation between frames preceding and succeeding in time; a correction value calculating unit calculating a correction value for the tone of the image, based on the image feature, a change in brightness of a screen of the display apparatus and the degree of correlation between frames; and a correcting unit correcting tone of the image using the correction value.

Preferably, the image consists of luminance component and chrominance component; and the correction value calculating unit includes a luminance correction value calculating unit calculating a first luminance correction value for the luminance component of a first frame as an object of correction, based on the image feature in accordance with a change in brightness of the screen, a chrominance correction value calculating unit calculating a chrominance correction value for the chrominance component of the first frame in accordance with the change in brightness of the screen, a memory unit storing a second correction value for the luminance component of a second frame preceding in time to the first frame, and a correction value selecting unit selecting any one of the first luminance correction value, the second luminance correction value, and a weighted mean correction value obtained as weighted mean of the first luminance correction value and the second luminance correction value in accordance with degree of correlation between the first frame and the second frame, and applying it to the correcting unit.

Preferably, the correction value selecting unit selects the weighted mean correction value in response to a determination that the degree of correlation is in a prescribed range, the first correction value in response to a determination that the degree of correlation is larger than the prescribed range, and the second correction value in response to a determination that the degree of correlation is smaller than the prescribed range.

Preferably, the image consists of luminance component and chrominance component; and the correcting unit includes a luminance correcting unit correcting the luminance component of the image using a luminance correction value for the luminance component, a chrominance correcting unit correcting the chrominance component of the image using a chrominance correction value for the chrominance component, and a correction value modifying unit modifying the luminance correction value such that each value of three primary color signals calculated from the luminance correction value and the chrominance correction value after correction does not exceed a prescribed value, and modifying the chrominance correction value based on chroma of the image before and after the correction.

Preferably, the image consists of luminance component and chrominance component; and the correcting unit includes a luminance correcting unit correcting the luminance component of the image using a luminance correction value for the luminance component, a chrominance correcting unit correcting the chrominance component of the image using a chrominance correction value for the chrominance component, and a chrominance modifying unit modifying the chrominance component such that a first chroma calculated from the luminance component after correction and the chrominance component before correction comes closer to a second chroma calculated from the luminance component and the chrominance component before correction.

### EFFECTS OF THE INVENTION

According to the present invention, when the brightness of the display unit is made darker, tone of the image is adaptively corrected in accordance with tone characteristic that varies dependent on the content of moving images. Therefore, degradation of image quality, such as saturation of portions having high tone values that leads to less expressiveness than the original image, can be prevented. It becomes possible to correct brightness while maintaining subjective image quality, and thereby to make the image more easily viewable.

### BRIEF DESCRIPTION OF THE DRAWINGS

FIG. 1 shows a structure of a transmissive liquid crystal display.

FIG. 2 is a graph showing a relation between tone of an image and seeming brightness.

FIG. 3 is a block diagram showing an exemplary configuration of a moving image playback apparatus in accordance with Embodiment 1.

FIG. 4 is a flowchart representing a process flow of a moving image playback apparatus 100.

FIG. 5 is a block diagram showing an exemplary configuration of a tone correcting unit 40.

FIG. 6 includes a conversion table and a corresponding graph of input/output relation.

FIG. 7 is a flowchart representing a process flow of tone correcting unit 40.

FIG. 8 shows an exemplary histogram.

FIG. 9 shows an exemplary result of processing by a histogram analyzing unit 41B.

FIG. 10 shows an example of correspondence between tone values before and after tone correction.

FIG. 11 shows a flow of a process for calculating a correction value in accordance with variation in histogram frequency.

FIG. 12 shows an example in which tone values related to calculation of correction value in a range including a local minimum point are compressed.

FIG. 13 shows input/output relation when FIG. 12(A) is used as the input and FIG. 12(B) is used as the output.

FIG. 14 is a block diagram showing an exemplary configuration of a tone correcting unit 40′.

FIG. 15 is a block diagram showing an exemplary configuration of a moving image playback apparatus in accordance with Embodiment 3.

FIG. 16 is a block diagram showing an exemplary configuration of a tone correcting apparatus in accordance with Embodiment 4.

FIG. 17 is a flowchart representing a process flow of a tone correcting apparatus 1600.

FIG. 18 is a block diagram representing an exemplary configuration of a correction value calculating unit 1602.

FIG. 19 shows parameter examples.

FIG. 20 shows an exemplary histogram.

FIG. 21 is a flowchart representing a process flow by a luminance correction value calculating unit 1801.

FIG. 22 shows examples of processes executed by luminance correction value calculating unit 1801.

FIG. 23 shows input/output relation corresponding to a chrominance table.

FIG. 24 shows correspondence between the correlation coefficient and the selected luminance conversion table.

FIG. 25 is a block diagram showing an exemplary configuration of a correcting unit 1603,.

FIG. 26 is a block diagram showing an exemplary configuration of a tone correcting apparatus 2600.

### DESCRIPTION OF REFERENCE CHARACTERS

10 image decoding unit, 20,80 filtering unit, 30 display unit, 40, 40′ tone correcting unit, 41, 1601 image feature extracting unit, 41A histogram calculating unit, 41B histogram analyzing unit, 42, 46, 1602 correction value calculating unit, 43, 47, 1603, 2603 correcting unit, 44 luminance component feature extracting unit, 45 chrominance component feature extracting unit, 50 display control unit, 60 operating unit, 70 switch, 90 recording device, 100, 200 moving image playback apparatus, 1600, 2600 tone correcting apparatus, 1604 frame correlation calculating unit, 1801, 2601 luminance correction value calculating unit, 1802, 2602 chrominance correction value calculating unit, 1803 conversion table memory for current frame, 1804 table selecting unit, 1805 conversion table memory for previous frame, 2501 chrominance enlarging unit, 2502 luminance correcting unit, 2503 chrominance correcting unit, 2504 correction value modifying unit.

### BEST MODES FOR CARRYING OUT THE INVENTION

In the following, embodiments of the present invention will be described. In the following description, the same portions are denoted by the same reference characters. Their names and functions are also the same. Therefore, detailed description thereof will not be repeated.

Prior to the description of the embodiments in accordance with the present invention, an overview of the invention will be given in the following.

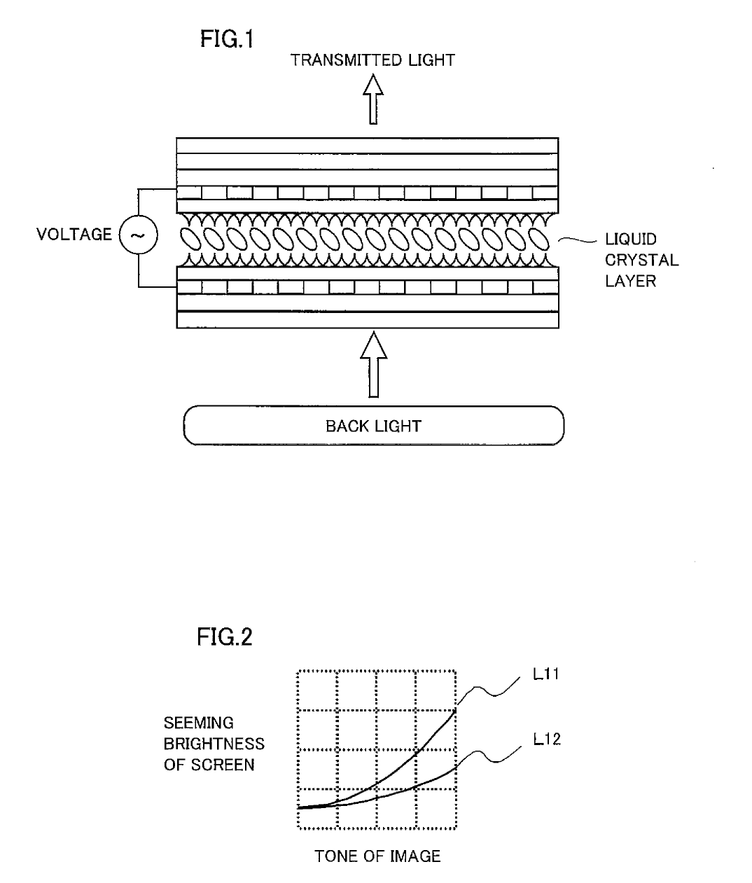

FIG. 1 shows a structure of a transmissive liquid crystal display.

Referring to FIG. 1, the present invention will be outlined.

A transmissive liquid crystal display has such a structure that an oily, transparent liquid crystal composition (liquid crystal layer) is positioned between two transparent substrates. On an inner surface of the transparent substrate, an electrode for applying a voltage to the liquid crystal is provided.

In the transmissive liquid crystal display, when light emitted from a backlight enters the liquid crystal layer, an AC voltage is applied to the liquid crystal layer. Application of the voltage changes arrangement of liquid crystal molecules, whereby the degree of transmission of incident light is controlled. Therefore, display luminance (hereinafter referred to as “brightness of the screen”) of transmissive liquid crystal display is determined by the output of backlight, independent from the image displayed on the display, while “seeming brightness of the screen” is determined by the output of backlight and transmittance of the liquid crystal layer. Transmittance of the liquid crystal layer changes, for example, in accordance with tone of the displayed image.

FIG. 2 is a graph representing relation between the tone of an image and seeming brightness.

Referring to FIG. 2, the relation between the tone of the image and the seeming brightness will be described.

In FIG. 2, L11 represents a relation between the tone of the image and the seeming brightness when the screen is set to certain brightness, and L12 represents the relation between the two when the brightness is set to a darker level than L11. When the backlight output is reduced to set the screen darker, the seeming brightness of the screen lowers, making it difficult to recognize the image. The seeming brightness of the screen, however, can be changed by the tone of the displayed image, as described above.

The present invention relates to a technique of improving easiness of viewing images by increasing tone of image pixels, when the brightness of the screen is lowered by reducing backlight output as described above.

The display apparatus is not limited to the transmissive liquid crystal display such as described above. The present invention is used for a display apparatus of which display luminance of the screen is determined independent of the displayed image.

### EMBODIMENT 1

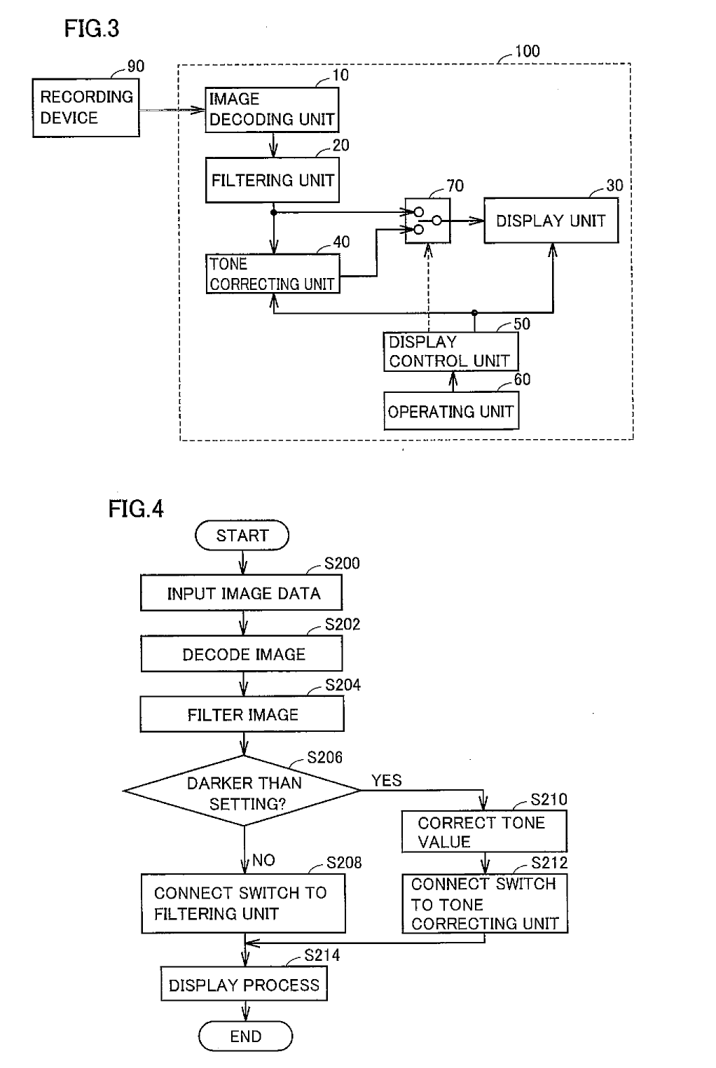

FIG. 3 is a block diagram showing an exemplary configuration of the moving image playback apparatus in accordance with Embodiment 1.

Referring to FIG. 3, the configuration of moving image playback apparatus in accordance with Embodiment 1 will be described. Moving image playback apparatus 100 includes an image decoding unit 10, a filtering unit 20, a display unit 30, a tone correcting unit 40, a display control unit 50, an operating unit 60, and a switch 70. A recording device 90 is connected to image decoding unit 10.

Image decoding unit 10 receives, as an input, a bit sequence of moving image data compressed by encoding, from recording device 90. The decoding unit decodes the input bit sequence to reconfigure one frame of moving image, and outputs it to filtering unit 20.

Filtering unit 20 filters the decoded image data, and reduces noise component that was generated in the process of decoding the encoded image. A low-pass filter for removing high-frequency component, for example, may be used.

Display unit 30 displays images, characters and figures, and is implemented by a liquid crystal, organic EL (Electro Luminescence) display or the like.

Display control unit 50 detects a signal from operating unit 60 and controls brightness setting of the screen of display unit 30 and stores the current brightness setting. The brightness setting refers to information indicating degree of brightness, if the brightness can be set in a prescribed number of stages. Assuming that the brightness can be changed in 5 stages, the brightness setting can be represented by a numerical value of 1 to 5. Though an initial value of brightness is set in advance, it may be changed by the user. Further, display control unit 50 controls switch 70 such that an output of filtering unit 20, or an output of tone correcting unit 40 is input to display unit 30. Further, display control unit 50 outputs the brightness setting of display unit 30 to tone correcting unit 40.

If it is determined from the brightness setting from display control unit 50 that the screen is set to be darker, tone correcting unit 40 corrects tone in accordance with the degree, utilizing frame-by-frame characteristic of tone of the moving image.

Operating unit 60 generates a signal in accordance with a user operation, and is implemented by a keyboard, a touch panel or the like.

Recording device 90 is, for example, a hard disk drive or a memory card. It provides image data to image decoding unit 10.

Various units as components of the present invention may be implemented by hardware including, for example, a microprocessor, a memory, a bus, interface and peripherals, and software that can be executed on the hardware. By way of example, image decoding unit 10 may be implemented by a DSP (Digital Signal Processor), filtering unit 20 and tone correcting unit 40 may be implemented by an FPGA (Field Programmable Gate Array), and display control unit 50 may be implemented by a microprocessor. Further, by successively executing programs opened on the memory, it is possible to process, store and output data on the memory or data input through the interface and thereby to realize functions of these units.

FIG. 4 is a flowchart representing a process flow of moving image playback apparatus 100.

Referring to FIG. 4, in the operations of moving image playback apparatus 100 configured as above, an operation of playback an input moving image will be described.

The moving image playback process starts when a bit sequence of moving image data compressed by encoding is input from recording device 90 to image decoding unit 10 (step S200). The moving image data may be received by a wired or wireless communication means. Alternatively, digital broadcast may be received. Generally, moving image data is taken out from data multiplexed on a series of bit sequences together with voice data.

Image decoding unit 10 decodes one frame of moving image from the bit sequence of input compressed moving image, and outputs the decoded image data to filtering unit 20 (step S202).

Next, filtering unit 20 filters the input one frame of moving image, to reduce noise component (step S204). In the filtering process, generally, it is possible to control degree of reducing noise component, which degree is referred to as filter strength in the present specification.

At S206, display control unit 50 determines whether or not the brightness of display unit 30 set by display control unit 50 in accordance with the signal from operating unit 60 has been changed to a darker direction from the initial setting.

If it is determined that the brightness has not been changed to a darker side from the initial setting (NO at step S206), display control unit 50 connects switch 70 to the side of filtering unit 20 (step S208).

If the brightness has been changed to the darker side from the initial setting (YES at step S206), correction appropriate for the image is made in accordance with tone features of the image (step S210). The method of correction at step S210 will be described later. Then, display control unit 50 connects switch 70 to the side of tone correcting unit 40 (step S212).

Step S214 is a display process, at which the image data output from filtering unit 20 or from tone correcting unit 40 is displayed on display unit 30. At the time of display, display unit 30 converts the image data to a displayable format as needed (for example, from YUV to RGB).

As described above, when the brightness has been changed to be darker than the setting, the image changed by tone correcting unit 40 to be easier to view on a darker screen is displayed on display unit 30.

Next, the configuration of tone correcting unit 40 and the process at tone correcting unit 40 (step S210) will be described.

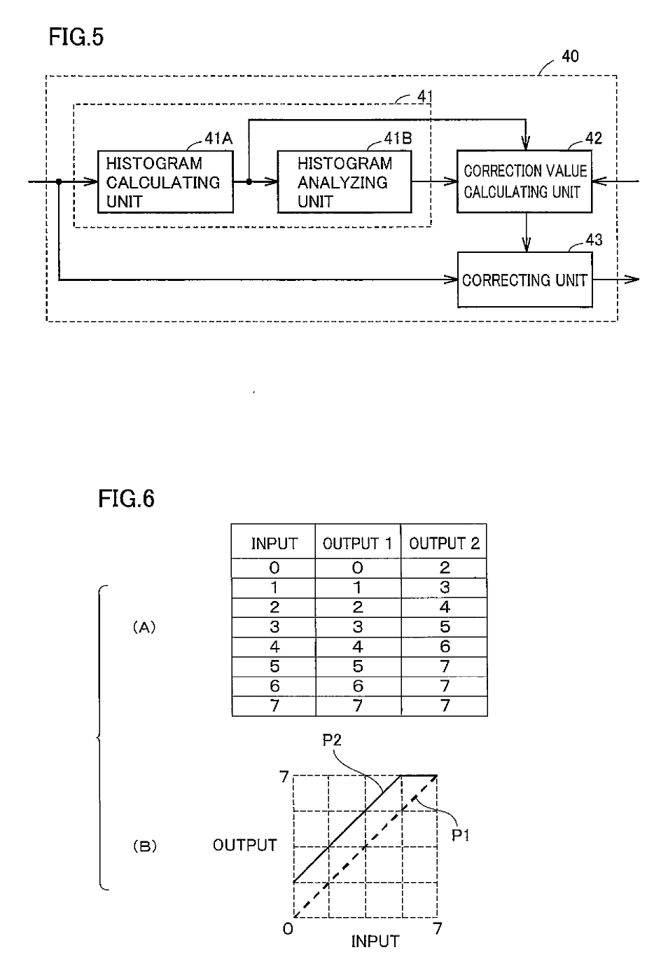

FIG. 5 is a block diagram showing an exemplary configuration of tone correcting unit 40.

First, referring to FIG. 5, the configuration of tone correcting unit 40 will be described.

Tone correcting unit 40 includes an image feature extracting unit 41, a correction value calculating unit 42, and a correcting unit 43. The image data is input to image feature extracting unit 41 and to correcting unit 43.

Image feature extracting unit 41 includes a histogram calculating unit 41A for calculating a histogram from the image data, and a histogram analyzing unit 41B for calculating a parameter representing image feature, by analyzing the histogram. Image feature extracting unit 41A analyzes the input image data, and extracts characteristic related to the tone of the image as image feature.

Correction value calculating unit 42 calculates a correction value to be applied for correcting tone, based on the image feature input from image feature extracting unit 41. Here, the correction value represents an output corresponding to the input tone value. Assume, for example, that the image is to be made brighter. Then, luminance component of the image should be increased. A method of increasing the luminance component is to add a prescribed value to the tone value of luminance component. This uniformly increases or enhances the luminance component of the image as a whole. In such a situation, the output value obtained by adding the prescribed value to the input tone value is the correction value.

Here, it is possible to use the degree how much the tone value of image data is increased as the correction value. Then, in the example above the prescribed value added to the tone component is the correction value.

Correction value calculating unit 42 stores, in the form of a conversion table, correction values in correspondence with tone values of the input, for the correcting process.

The conversion table will be described.

FIG. 6 includes a conversion table and a corresponding graph of input/output relation. FIG. 6(A) shows an example of the conversion table for tone of 8 levels, and FIG. 6(B) is a graph representing input/output relation corresponding to FIG. 6(A).

In the conversion table, output values are allocated to respective input values. In FIG. 6(A), in the column of Output 1, inputs are directly used as outputs. In the column of Output 2, values obtained by adding 2 (+2) to the inputs are allocated to inputs 2 to 5, and 7 is allocated to inputs 6 and 7. In FIG. 6(B), the abscissa represents the input value and the ordinate represents the output value. Here, Output 1 of FIG. 6(A) corresponds to P1, and Output 2 corresponds to P2.

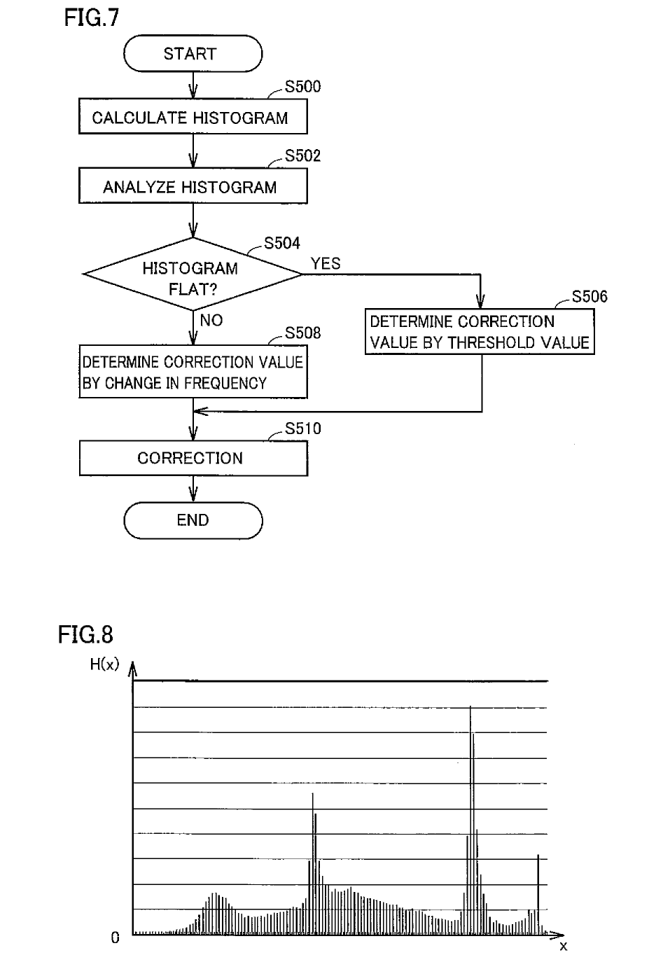

FIG. 7 is a flowchart representing a process flow of tone correcting unit 40.

Referring to FIG. 7, the process flow (process at step S210) of tone correcting unit 40 will be described.

When the process of step S210 starts, a histogram of the input image is calculated by histogram calculating unit 41A (step S500). Digitized image data is a collection of pixels arranged in horizontal and vertical directions, and each pixel has a tone value. The tone value represents intensity of brightness (pixel intensity) of the pixel. It may also be considered to represent degree of color density (density). To histogram calculating unit 41A, pixel data of the input image are successively input. By counting the number of input pixel data that have the same tone value, the histogram is calculated. The number of pixels that are within a width N of tone values (N is a positive integer) may be counted for every width N (if the width N is 1, it is the same as counting the number pixel by pixel). For instance, if N=4, frequency is counted in the tone range of 0 to 3, 4 to 7 and 8 to 11, range by range.

FIG. 8 shows an example of the histogram.

As shown in FIG. 8, the histogram is realized by a graph in which the abscissa represents tone value x and the ordinate represents frequency (number of pixels) H(x).

Next, histogram analyzing unit 41B analyzes the histogram (step S502). Here, a tone value of which frequency attains local maximum or local minimum is derived, and output as a parameter representing image feature, to correction value calculating unit 42. In the following description, the tone value that corresponds to the local maximum of the histogram will be referred to as a local maximum point, and the value that corresponds to the local minimum will be referred to as a local minimum point.

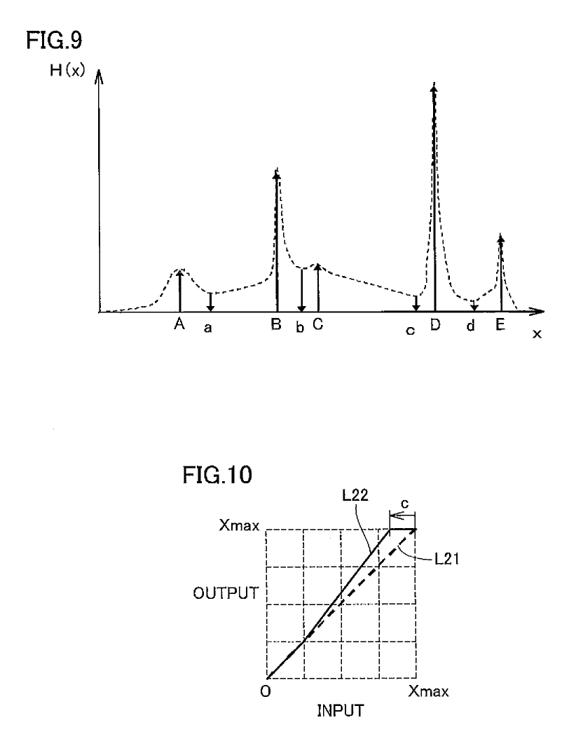

FIG. 9 shows an exemplary result of processing by histogram analyzing unit 41B.

FIG. 9 corresponds to the result of histogram analyzing unit 41B taking out local maximums and local minimums, from the histogram shown in FIG. 8. In FIG. 9, an upward arrow represents a local maximum value and a downward arrow represents a local minimum value, and A to E are local maximum points and a to d are local minimum points.

In the derivation of local maximum/local minimum, it is important not to be influenced by delicate variation of the histogram. For instance, it may be effective to calculate a plurality of histograms with the width N of tone values for calculating the histogram varied, by histogram calculating unit 41A, to derive local maximum/local minimum in hierarchical manner. Specifically, using different widths N1 and N2 (where N1>N2), local maximum/local minimum may be derived from the histogram as a whole with the width N1 first, and then, local maximum/local minimum may be newly derived from around the local maximum/local minimum derived first, from the histogram with width N2.

Further, histogram analyzing unit 41B may take out local maximum/local minimum from the histogram after calculating moving average, using a plurality of neighboring frequencies of the input histogram. Moving average makes smooth the frequency variation of the histogram, and hence, makes it easier to detect a peak.

The number of frequencies to be subjected to moving average calculation may be changed in accordance with the filter strength of filtering by the filtering unit 20 shown in FIG. 3. If high filter strength is applied (that is, noise component is much reduced), variation in frequency distribution becomes smaller and, therefore, the number of frequencies to be subjected to moving average calculation can be reduced. On the contrary, if low filter strength is applied, there would be considerable variation in frequency distribution, and therefore, the number of frequencies to be subjected to moving average calculation is increased.

Returning to FIG. 7, at subsequent steps S504 to S510, a correction value to be used for the correcting process is calculated by correction value calculating unit 42. Correction value calculating unit 42 calculates the correction value based on the histogram calculated by histogram calculating unit 41A.

At step S504, correction value calculating unit 42 determines whether or not the histogram is flat (indicating that frequencies of the histogram are substantially uniform), using the parameter input from histogram analyzing unit 41B. By way of example, if the magnitude of frequency to be the local maximum/local minimum is within a prescribed range of values set in advance, the histogram may be determined to be flat, or if the difference between the frequency to be the local maximum and the frequency to be the local minimum is smaller than a prescribed value, the histogram may be determined to be flat. Alternatively, whether the histogram is flat or not may be determined by histogram analyzing unit 41B, and the result of determination may be output to correcting value calculating unit 42. Histogram analyzing unit 41B determines that the histogram is flat if each of the frequencies is within a range of prescribed values, and not flat otherwise.

If the histogram is flat (YES at step S504), the correction value is determined based on the frequency of the histogram (step S506). Specifically, the histogram after tone correction is calculated, and correction value for each tone value is determined such that the sum of frequencies within a prescribed range set in a range of high tone (hereinafter referred to as “high tone range”) does not exceed a prescribed threshold value. The method of tone correction here is not limited. An example will be described in the following.

FIG. 10 shows an example of a correspondence between tone values before and after tone correction.

In FIG. 10, the abscissa represents an input value and the ordinate represents an output value. Here, L21 indicates the input/output relation before correction, and L22 indicates the input/output relation after correction. In the relation shown in FIG. 10, low tone value is converted to be corrected slightly, and the intensity of correction increases as the tone becomes higher.

Correction value calculating unit 42 holds an initial conversion table having such a correspondence relation shown by L22 of FIG. 10. First, based on the initial conversion table, the histogram is corrected. After correction, the frequency of tone value attaining the maximum level Xmax is calculated. This corresponds to a sum of frequencies of tone values that are within the range of width c from Xmax, in the histogram before correction. When the width c is increased, the sum of frequencies also increases and when the sum of frequencies exceeds a prescribed threshold, it is set as the limit correction value. In order to prevent saturation of tone (so as to prevent display of unnatural image) by the correction, the number of pixels that have maximum level tone values is set in advance as the prescribed threshold. If the sum of frequencies of tone values within the range of width c does not exceed the prescribed threshold value, correction value calculating unit 42 stores the initial conversion table as the conversion table. If the calculated sum of frequencies exceeds the prescribed threshold value, the width c is made narrower, and the conversion table is recalculated so that the frequencies of tone values attaining the maximum level Xmax is within the prescribed threshold value. Correction value calculating unit 42 stores the recalculated conversion table as the conversion table.

One example of tone correction when the histogram is flat is as described above. Other than the method above, it may be possible to add a prescribed value to each pixel, or gamma correction may be made. In any case, the input/output relation of the tone values such as shown in FIG. 10 is determined, and correction value calculating unit 42 stores the relation as the conversion table.

The threshold value is not limited to a fixed value, and it may be adaptively determined using a sum of frequencies in the prescribed range of the histogram before correction. Here, it is determined to be T=f(S), where T is the threshold value and S is the sum of frequencies. The function f is a linear or non-linear function.

Returning to FIG. 7, if the histogram is not flat (NO at step S504), the correction value is determined in accordance with the variation in histogram frequencies (step S508). First, the range of tone values is divided into a range containing one local maximum point and a range containing one local minimum point. Here, frequencies are large near the local maximum point and, on the contrary, frequencies are small near the local minimum point. Therefore, a mean value of frequencies included in each range would be small in the range including the local minimum value. Therefore, even if the tone width is made narrower (tone is compressed) without changing the total sum of frequencies in the range including the local minimum point, subjective image quality is not degraded. The tone value that becomes newly available because of the compression of tone in the range including the local minimum may be used for the range including the local maximum value. Therefore, it becomes possible, for example, to increase the tone in this range. As to the range including the local minimum point, correction value is calculated such that the range becomes narrower to the side of higher tone values.

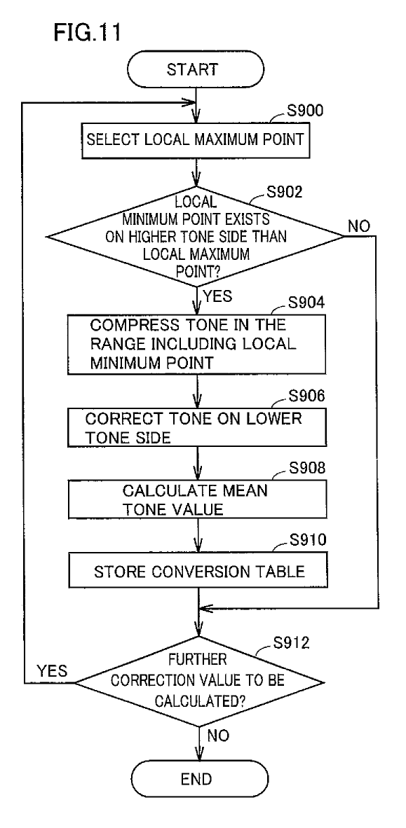

FIG. 11 represents a process flow of calculating the correction value in accordance with variation in histogram frequencies.

Referring to FIG. 11, the method of calculating the correction value at step S508 will be described.

At step S900, one local maximum point is selected from local maximum points derived at step S502. By way of example, a local maximum point assuming the largest local maximum value is selected. At subsequent step S902, whether or not there is any local minimum point on the higher tone side of selected local maximum point is determined. If there is a local minimum point (YES at step S902), tone of the range including the local minimum point is compressed (step S904).

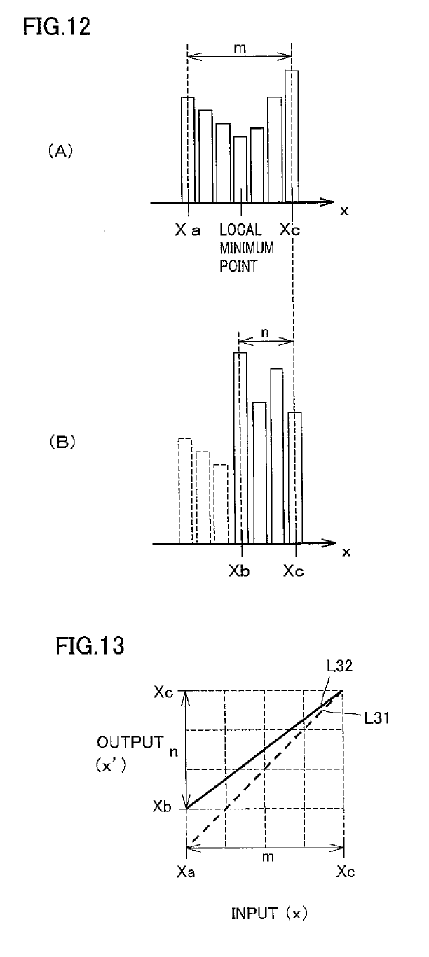

FIG. 12 shows an example in which tone values related to calculation of correction value in a range including a local minimum point are compressed. FIG. 12(A) is a histogram showing a range that includes only one local minimum point, of the histogram before tone correction, and FIG. 12(B) is a histogram after correction when tone is corrected using the correction value, which will be determined in the following.

Referring to FIG. 12, tone compression performed at step S904 will be described.

In FIG. 12(A), m represents the width of the range covering local minimum point, Xa represents tone value at the left end, and Xc represents the tone value at the right end. Here, Xa and Xc are points that internally divide neighboring local maximum point and local minimum point with a prescribed ratio (for example, ½). As can be seen from FIG. 12(B), in the range after compression, the tone value at the right end is unchanged at Xc) while the tone value at the left end assumes Xb, and the width of the range becomes n (where n<m). Specifically, the relations m=Xc−Xa+1, n=Xc−Xb+1 hold, and once Xc is determined, n is determined.

The conversion of tone range can be effected by using a linear equation x′=a·x+b (where x represents a tone value as an input, and a and b are constants).

FIG. 13 shows input/output relation when FIG. 12(A) is used as the input and FIG. 12(B) is used as the output.

In FIG. 13, L31 represents the input/output relation without correction, and L32 represents the relation of linear equation mentioned above. As can be seen from FIG. 13, relations of a=n/m, b=(1−n/m)·Xc hold.

Correction value calculating unit 42 compresses the tone values in the range including the local minimum value based on the correspondence relation such as described above. By changing the range including the local minimum point, (m−n) tone values, that are no longer used, result in the lower tone side than the range. Therefore, it becomes possible to increase the tone lower than this range by (m−n). The relation between m and n is determined based on how much the tone is to be enhanced, and on the histogram characteristic. If the change in tone is to be made larger, the value n should be made smaller. The smaller becomes n, however, the average frequency of the range including the local minimum point becomes larger, which means that larger number of pixels must be expressed with smaller number of tone levels. Thus, subjective image quality degrades. In order to prevent this, the width n is limited (in other words, Xc is limited) such that average frequency in the range including the local minimum does not exceed the frequency at the local maximum point.

Returning to FIG. 11, at step S906, correction value calculating unit 42 performs a correction of adding (m−n) to the tone value on the lower tone side. At step S908, correction value calculating unit 42 calculates a mean value of tone values of the entire image subjected to the correction described above. At step S910, correction value calculating unit 42 stores the conversion table. For the range including the local minimum point, the input/output relation such as described in relation to step S904 is stored, and for the tone on the lower side than the range including the local minimum point, the input/output relation as described in relation to step S906 is stored, as the conversion table (step S910). Further, a difference between the mean value calculated at step S908 and the mean value of tone values before correction is used as the amount of change. The amount of change and the conversion table are related to each other.

At step S902, if there is no local minimum point on the side of higher tone than then local maximum point (NO at step S902), the process proceeds to step S912.

At step S912, whether correction value is to be further calculated or not is determined. If further calculation is to be done (YES at step S912), the process returns to step S900. Otherwise (NO at step S912), the process ends.

Determination is done considering, for example, the following factors. Dependent on how much the brightness of the screen is changed by display control unit 50, degree of appropriate correction effected by tone correcting unit 40 differs. Therefore, how much the tone value of the image as a whole is to be enhanced in correspondence to the degree of change in screen brightness is set in advance as a target value. The target value is compared with the amount of change related to the conversion table at step S908. If the difference between the amount of change and the target value is not within a predetermined range, a further conversion table is obtained. In that case, the local maximum point selected at step S900 is the one that assumes the largest local maximum value among the local maximum points that are not selected yet. If the difference between the amount of change and the target value does not fall within the determined range, a conversion table that minimizes the difference between the amount of change and the target value is output.

Selection of the local maximum point as the object of processing at step S900 has some degree of freedom. In the foregoing, the local maximum point having the largest local maximum value (range including local maximum point D of FIG. 9) is used as the object of processing. Other than this method, a range including a plurality of local maximum points, such as the local maximum point of largest local maximum value and the local maximum point of second largest local maximum value, for example, may be used as the object of processing.

Further, the width n of the range including the local minimum value may be changed appropriately at step S904 to obtain conversion tables for a plurality of correction values calculated using the plurality of widths n, so that the target value can be attained.

Returning to FIG. 7, finally, the correcting unit 43 executes the image correcting process (step S510). Here, the correcting unit 43 performs the process for correcting the input image data, based on the conversion table stored in correction value calculating unit 42 at steps S506 and S508. For instance, when brightness setting of display unit 30 is input from display control unit 50, a conversion table stored in correction value calculating unit 42 in relation to the amount of change in tone corresponding to the brightness setting (or the closest value) is read, and the tone values of the input image data are converted accordingly.

As described above, the characteristic related to the tone of moving image is extracted as image feature, and the correction value to be used for the correcting process is calculated based on the feature. Therefore, an adaptive tone correction is realized. Therefore, even when brightness of the screen is made darker, easiness of viewing the image can be improved without unnatural correction.

If histogram distribution does not much differ among moving image frames, tone correcting unit 40 may output the same correction value. Generally, continuous frames of moving images have high correlation except for a scene change, and therefore, when correction value is calculated frame by frame, the same calculation tends to be repeated. Omission of such calculation of the correction value leads to reduced process load and, in addition, it prevents unnatural change in tone between the frames of moving image. The correlation between frames may be determined by calculating coefficient of correlation between histograms of the current frame and the previous frame, with the histogram calculated at histogram calculating unit 41A regarded as a kind of time-sequential data. For instance, if the coefficient of correlation is 1.0, the correction value for the previous frame may be used directly, and if the coefficient of correlation is not higher than 0.2, the correction value for the current frame should be calculated. Otherwise, the correction value calculated for the current frame may be modified by the correction value for the previous frame, in accordance with the value of coefficient of correlation.

### EMBODIMENT 2

In Embodiment 2, moving image playback apparatus 100 includes a tone correcting unit 40′ in place of tone correcting unit 40. Other components of moving image playback apparatus 100 are the same.

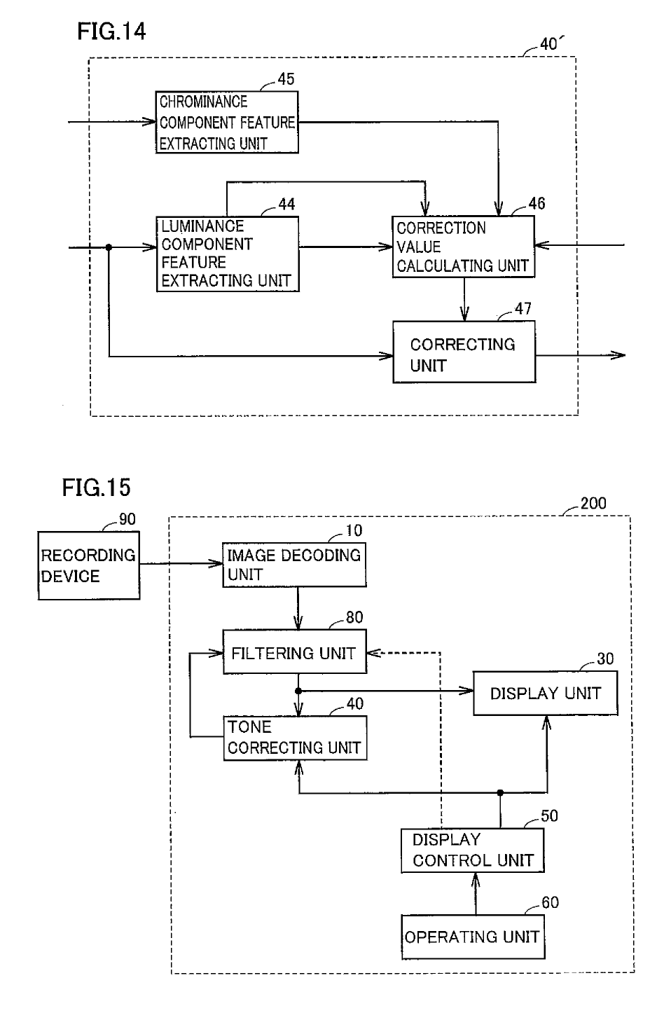

FIG. 14 is a block diagram showing an exemplary configuration of tone correcting unit 40′.

Referring to FIG. 14, tone correcting unit 40′ will be described. Of the image data of YUV color format input to tone correcting unit 40′, luminance (Y) component is input to a luminance component feature extracting unit 44, and chrominance components (U, V) are input to a chrominance component feature extracting unit 45.

Luminance component feature extracting unit 44 extracts feature of the luminance component from the characteristics related to tone of luminance component, in a similar manner as image feature extracting unit 41 described above.

Chrominance component feature extracting unit 45 takes out as the feature of chrominance component the dynamic range of chrominance component (interval between the maximum and minimum tone values of which frequency is not 0 in the histogram).

Correction value calculating unit 46 calculates the correction value for the luminance component of the image in a similar manner as correction value calculating unit 42 shown in FIG. 5. Specifically, it executes steps S500 to S510 shown in FIG. 7. Here, at step S506, the correction value is determined based on the frequency of histogram of luminance component.

Correction value calculating unit 46 changes the threshold value used for determining correction value in accordance with the width of dynamic range of chrominance component input from chrominance component feature extracting unit 45. That the dynamic range is wide means that color components have high contrast, and therefore, the image seems sharper than when the dynamic range is narrow. Even if the threshold value used for determining correction value is made small, easiness for viewing the image can be improved. Therefore correction value calculating unit 45 adjusts the threshold value such that when the chrominance component has wide dynamic range the threshold for determining correction value is made small and, on the contrary, when the dynamic range is narrow, the threshold value is made large.

The feature of chrominance component is not limited to the width of dynamic range. The magnitude of maximum frequency in the histogram, or the magnitude of tone value of which frequency is the highest may be used.

As described above, the characteristic related to the tone of moving image is extracted as image feature, and the correction value to be used for the correcting process is calculated based on the feature. Therefore, an adaptive tone correction is realized. As the correction value of luminance component is adjusted in accordance with the histogram distribution of chrominance component, easiness of viewing the image can be improved in more delicate manner.

### EMBODIMENT 3

FIG. 15 is a block diagram showing an exemplary configuration of a moving image playback apparatus in accordance with Embodiment 3.

Referring to FIG. 15, the configuration of moving image playback apparatus 200 in accordance with Embodiment 3 will be described. Moving image playback apparatus 200 includes an image decoding unit 10, a filtering unit 80, a display unit 30, a tone correcting unit 40, a display control unit 50, and an operating unit 60. In Embodiment 3, switch 70 of moving image playback apparatus 100 in accordance with Embodiment 1 is removed, and filtering unit 80 is provided in place of filtering unit 20.

Filtering unit 80 performs filtering process on the decoded image output from image decoding unit 10 to reduce noise, and performs filtering process different from the previous filtering process on the image after correction output from tone correcting unit 40 to make the image sharper. In accordance with a control signal from display control unit 50, the filtered image data is output. The filtering process for sharpening can be realized by a neighborhood operation of a prescribed size using a local operator, similar to the filtering process for noise reduction. By way of example, sharpening can be realized by calculating a spatial quadratic differential (Laplacian) image by using a local operator and by subtracting the image from the original image. When we represent the output and input of filtering process by y and x, there is a relation of y=x−w·L (L represents tone value of the pixel corresponding to x in the Laplacian image, and w represents a coefficient for weighting). When the brightness of the screen decreases, amount of light entering human eyes decreases and, as a result, the image displayed on display unit 30 seems blurred. Such blurriness can be eliminated by sharpening the image. Here, the image seems more blurred if the screen brightness becomes darker. Therefore, the degree of sharpening by filtering unit 80 may be controlled such that coefficient w is adjusted to increase sharpness at an edge portion of the image when the brightness of the screen is reduced.

As described above, the characteristic related to the tone of moving image is extracted as image feature, and the correction value to be used for the correcting process is calculated based on the feature. Therefore, an adaptive tone correction is realized. Even when the screen brightness is made darker, sharpness of the image is improved without unnatural correction, and easiness of viewing the image can be improved.

### EMBODIMENT 4

In Embodiment 4, an example of tone correcting apparatus incorporated in the moving image playback apparatus for performing tone correction will be described. In the following, the tone correcting apparatus in accordance with the present embodiment will be described as incorporated in place of tone correcting unit 40 of Embodiment 1.

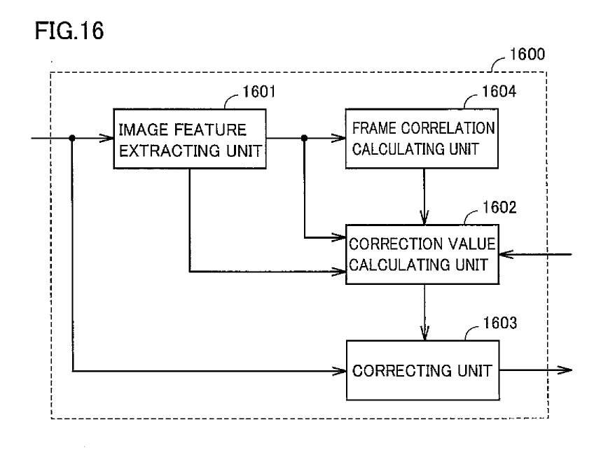

FIG. 16 is a block diagram showing an exemplary configuration of the tone correcting apparatus in accordance with Embodiment 4.

Referring to FIG. 16, the configuration of tone correcting apparatus 1600 in accordance with Embodiment 4 will be described. Tone correcting apparatus 1600 includes an image feature extracting unit 1601, a correction value calculating unit 1602, a correcting unit 1603, and a frame correlation calculating unit 1604. In the present embodiment, frame-by-frame image data of the moving image in YUV format are input to image feature extracting unit 1601 and correcting unit 1603.

Image feature extracting unit 1601 is functionally the same as image feature extracting unit 41 shown in FIG. 5, and it calculates frame-by-frame histogram of the input moving image and a parameter representing the image feature in the histogram. The histogram of each frame is applied to frame correlation calculating unit 1604 and to correction value calculating unit 1602, and the parameter representing the image feature is applied to correction value calculating unit 1602.

Frame correlation calculating unit 1604 holds the frame histogram in an internal memory. When the histogram of a frame as an object of tone correction (hereinafter referred to as a “current frame”) is applied, it calculates degree of correlation between the current frame and a frame preceding in time (hereinafter referred to as a “previous frame”).

Here, as an index representing the degree of correlation, by way of example, a coefficient of correlation is calculated. When we represent tone values of pixels in the image data of current and previous frames by two sample sequences {xᵢ|i=1˜N (N is the number of pixels in the frame)} and {yᵢ|i=1˜N}, the coefficient of correlation R is defined by Equation (1) below.

$$R = \frac{{\sum }_{i} ( {x}_{i} - {m}_{x} ) ( {y}_{i} - {m}_{y} )}{{σ}_{x} {σ}_{y}} \qquad ( 1 )$$

Here, mₓ and m_{y} represent mean values of sample sequences x and y, and σₓ and σ_{y} represent standard deviation of sample sequences x and y. The coefficient of correlation R defined by Equation (1) assumes a value in the range of −1 to 1.

Correction value calculating unit 1602 calculates a correction value for the luminance component and a correction value for the chrominance component, from the histogram of current frame and corresponding parameter applied from image feature extracting unit 1601, setting of screen brightness input from the outside, and the degree of correlation applied from frame correlation calculating unit 1604, forms a conversion table, and applies the table to correcting unit 1603. Details of the method of forming the conversion table will be described later. Correction value calculating unit 1602 holds an internal memory for storing the conversion table.

Correcting unit 1603 has a function of correcting the current frame using the correction values for the luminance component and the chrominance component applied from correction value calculating unit 1602, and a function of modifying the corrected image data so that visual sense of strangeness does not result from the correction. Details of the method of correction and modification will be described later.

The image data output from correcting unit 1603 may be displayed on a display unit provided on the moving image playback apparatus, or it may be displayed on an external display apparatus.

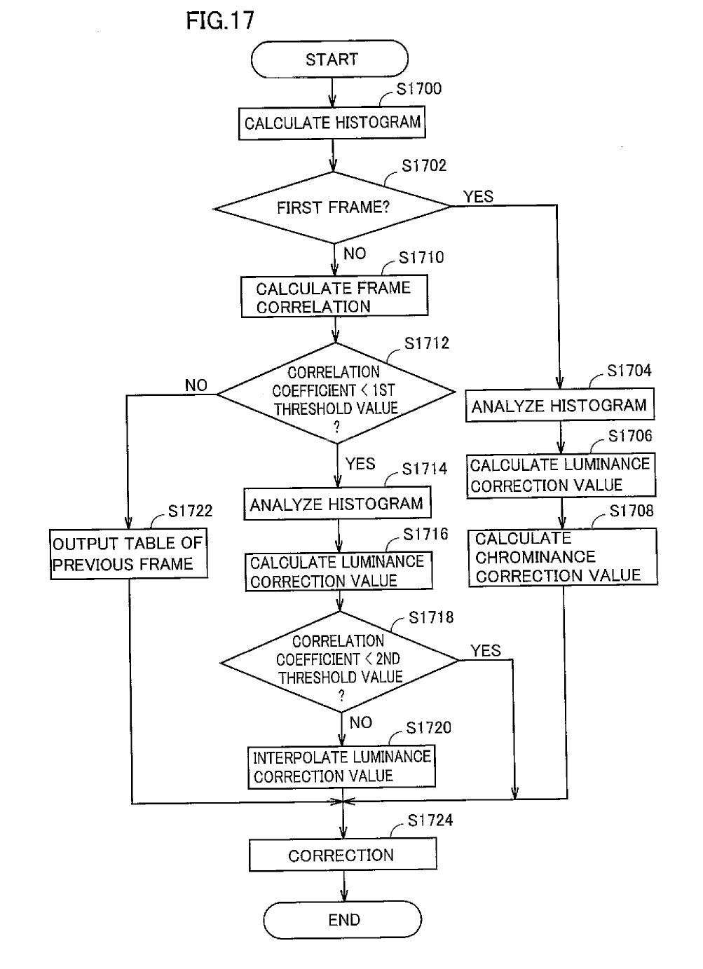

FIG. 17 is a flowchart representing a process flow by tone correcting apparatus 1600.

Referring to FIG. 17, the process flow of tone correcting apparatus 1600 will be outlined. FIG. 17 includes the same process steps as in the flowchart of FIG. 7, Detailed description of these steps will not be repeated, and corresponding steps will be denoted.

When the process starts, image feature extracting unit 1601 calculates a histogram of the applied current frame (step S1700, corresponding to step S500).

Then, image feature extracting unit 1601 determines whether or not the current frame is the first frame of the moving image sequence (step S1702). If it is determined to be the first frame (YES at step S1702), the process proceeds to step S1704. If it is determined not to be the first frame (NO at step S1702), the process proceeds to step S1710. The first frame refers to the first frame of a series of frame sequences of the moving image input to the tone correcting apparatus 1600, and it may also refer to a starting frame of a specific scene included in the moving image sequence.

At step S1704, image feature extracting unit 1601 analyzes the histogram (step S1704, corresponding to step S502). The resulting parameter is applied to correction value calculating unit 1602.

Thereafter, at step S1706, correction value calculating unit 1602 calculates the correction value for the luminance component, and stores the conversion table for the luminance component (corresponding to steps S504 to S508).

Further, correction value calculating unit 1602 calculates the correction value for the chrominance component, and stores the conversion table for the chrominance component (step S1708). The conversion tables calculated at steps S1706 and S1708 are applied to correcting unit 1603.

At step S1710, frame correlation calculating unit 1604 calculates the coefficient of correlation R between the previous frame and the current frame, and applies it to correction value calculating unit 1602.

At step S1712, correction value calculating unit 1602 determines whether or not the coefficient of correlation R is smaller than a first threshold value. If the coefficient of correlation R is determined to be smaller than the first threshold (YES at step S1712), the process proceeds to step S1714. If the coefficient of correlation R is determined to be not smaller than the first threshold value (NO at step S1712), the process proceeds to step S1722.

At step S1714, correction value calculating unit 1602 analyzes the histogram of current frame, as at step S1704.

Then, at step S1716, correction value calculating unit 1602 calculates the correction value for the luminance component and stores the conversion table for the luminance component, as at step S1706.

Further, at step S1718, correction value calculating unit 1602 determines whether or not the coefficient of correlation R is smaller than a second threshold value. It is noted that the second threshold value is selected to be smaller than the first threshold value.

If the coefficient of correlation R is determined to be smaller than the second threshold value (YES at step S1718), correction value calculating unit 1602 applies the conversion table stored at step 81716 to correcting unit 1603. Specifically, it is determined that the current frame and the previous frame are not correlated, and hence, the conversion table for luminance component for the current frame is applied to correcting unit 1603.

If the coefficient of correlation R is determined to be not smaller than the second threshold value (NO at step S1718), correction value calculating unit 1602 interpolates the correction value of the conversion table for luminance component of the current frame formed at step 81716 based on the conversion table for luminance component of the previous frame, and applies the conversion table for the chrominance component and the interpolated conversion table for luminance component, to correcting unit 1603. Specifically, the current frame and the previous frame are determined to be correlated to some extent, and therefore, the conversion table for luminance component interpolated for the current frame is applied to correcting unit 1603.

At step S1722, correction value calculating unit 1602 applies the conversion table used for tone correction for the previous frame to correcting unit 1603. Specifically, the current frame and the previous frame are determined to be correlated, and therefore, the conversion table for luminance component for the previous frame is applied as the conversion table for luminance component for the current frame, to correcting unit 1603.

Finally, at step S1724, correcting unit 1603 executes the tone correcting process of the current frame, using the applied conversion table,.

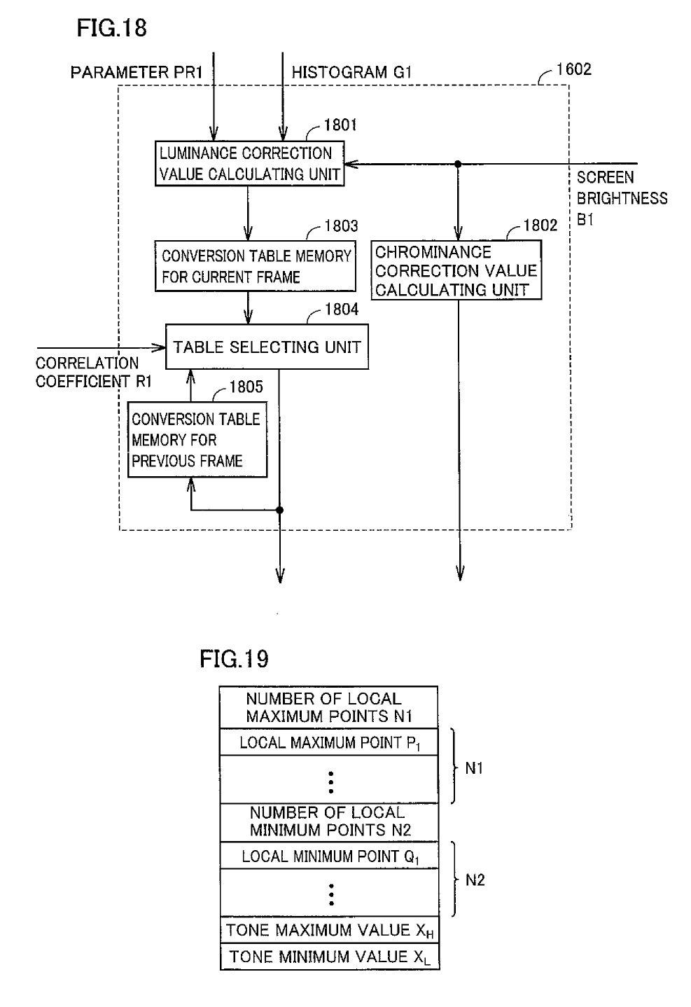

FIG. 18 is a block diagram representing an exemplary configuration of correction value calculating unit 1602.

Referring to FIG. 18, the configuration of correction value calculating unit 1602 will be described.

The unit includes a luminance correction value calculating unit 1801 calculating a correction value for luminance component (Y), a chrominance correction value calculating unit 1802 calculating a correction value for chrominance component (U, V), a table selecting unit 1804 selecting a conversion table in accordance with the coefficient of correlation, a conversion table memory 1803 for storing a conversion table for the current frame, and a conversion table memory 1805 for the previous frame, for storing the conversion table for the previous table.

In the present embodiment, a coefficient of correlation is used as an index representing the degree of correlation. As the index of degree of correlation, a sum of absolute values of differences of histogram data (for example, the absolute value of difference is |xᵢ−yᵢ|, where xᵢ represents the frequency of each tone value of the histogram of current frame, and yᵢ represents the frequency of each tone value of the histogram of previous frame) may be used, or other index may be used.

In the following, operations of luminance correction value calculating unit 1801, chrominance correction value calculating unit 1802 and table selecting unit 1804 will be described.

(Operation of Luminance Correction Value Calculating Unit 1801)

Luminance correction value calculating unit 1801 calculates a luminance conversion table for correcting the degree of brightness (pixel intensity) of the pixel in accordance with brightness B1 of the screen, based on a histogram G1 applied from image feature extracting unit 1601 and on a corresponding parameter PR1. The pixel intensity corresponds to the luminance component (Y) of the YUV format. The brightness of screen is set independent from the images displayed on the display unit, as described above. In the present embodiment, it is applied from display control unit 50 controlling the brightness of screen at display unit 30.

Before describing the operation of luminance correction value calculating unit 1801, first, the parameters will be described.

FIG. 19 shows parameter examples.

Referring to FIG. 19, the parameters will be described. A parameter is a value representing image feature. In the present embodiment, the number N1 (N1 is a positive integer) of local maximum points in the histogram, local maximum points Pᵢ (where 1≦i≦N1), the number N2 of local minimum points (where N2 is a positive integer), local minimum points Qᵢ (where 1≦i≦N2), maximum value X_{H} of tone, and minimum value X_{L} of tone are used as parameters. Here, the tone value of a point where the frequency of histogram attains local maximum is regarded as the local maximum point, and the tone value where the frequency attains local minimum is regarded as the local minimum point. Further, the highest tone value of which histogram frequency is not zero is regarded as the maximum value of tone, and the lowest tone value of which histogram frequency is not zero is regarded as the minimum value of tone. In the histogram related to the tone of an image, image feature such as whether the histogram is flat or not, can be known from these values.

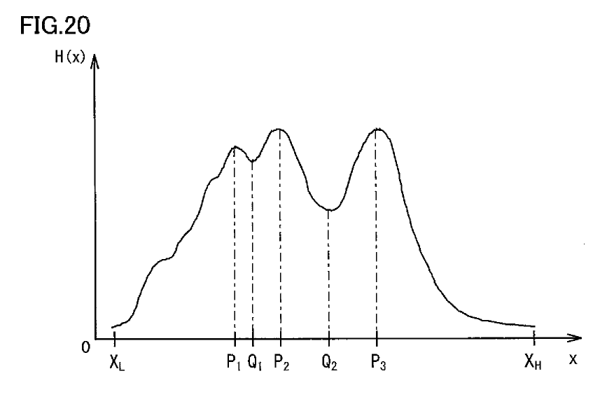

FIG. 20 shows an exemplary histogram.

Referring to FIG. 20, the parameters will be specifically described.

In the histogram of FIG. 20, local maximum points P₁, P₂, P₃, local minimum points Q₁, Q₂, maximum value of tone X_{H} and minimum value of tone X_{L} are denoted. For the histogram, image feature extracting unit 1601 applies values of the number of local maximum points N1=3, local maximum points P₁, P₂ and P₃, the number of local minimum points N2=2, local minimum points Q₁ and Q₂, maximum value of tone X_{H} and minimum value of tone X_{L}, as parameters, to luminance correction value calculating unit 1801.

Using the parameters mentioned above, luminance correction value calculating unit 1801 calculates the correction value for the luminance component.

The operation of luminance correction value calculating unit 1801 is the same as the operation of steps S504 to S508 shown in FIG. 7. Here, in connection with the process of step S508, an example of processing different from that shown in FIG. 11 will be described.

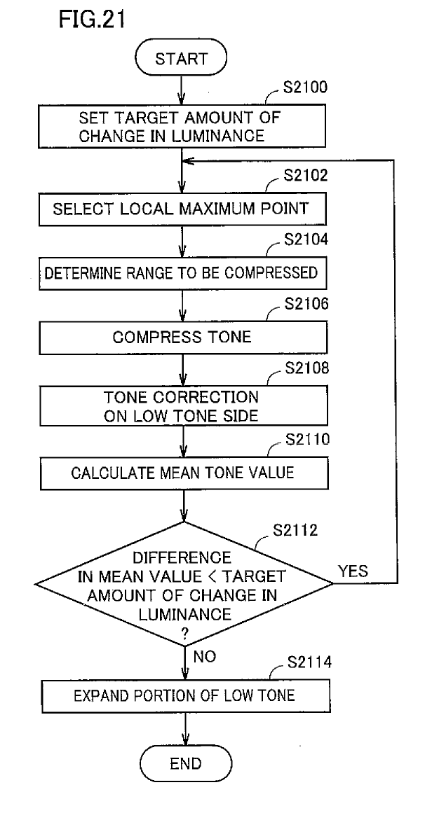

FIG. 21 is a flowchart representing a process flow by luminance correction value calculating unit 1801.

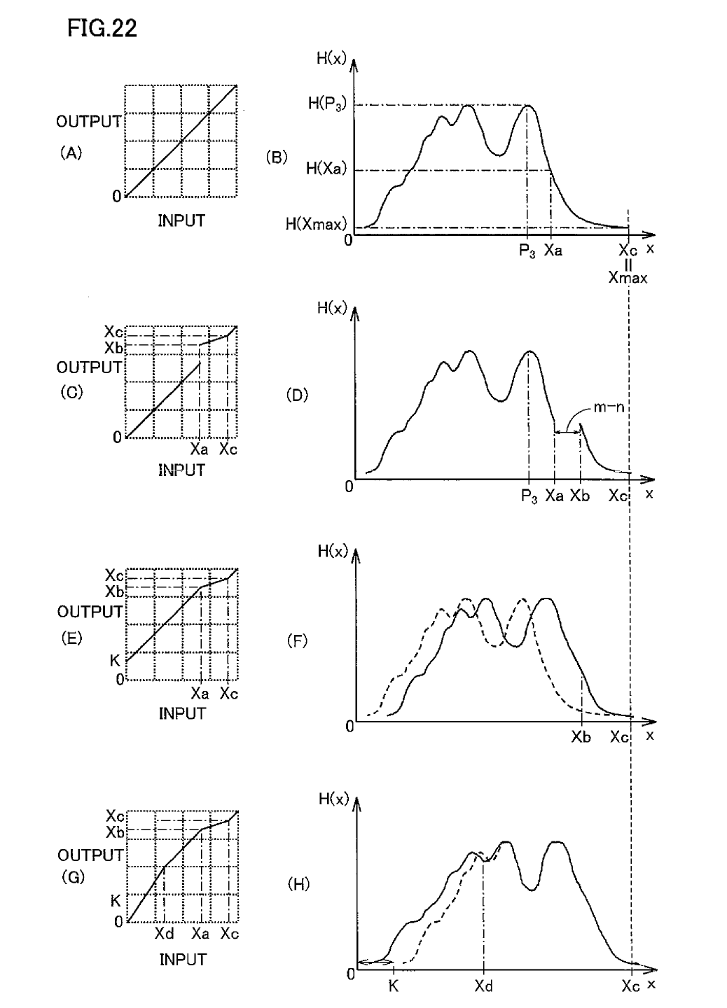

FIG. 22 shows examples of processes executed by luminance correction value calculating unit 1801.

Referring to FIGS. 21 and 22, the process executed by luminance correction value 1801 will be described. In FIG. 22, (A), (C), (E) and (G) are graphs representing input/output relations corresponding to the conversion tables, and (B), (D), (F) and (H) show histograms as corrected in accordance with the conversion tables. FIG. 22(A) is a graph showing the input/output relation in correspondence with the initial conversion table and FIG. 22(B) is a histogram output in accordance with the input/output relation shown in FIG. 22(A), when the histogram shown in FIG. 20 is input.

At step S2100, luminance correction value calculating unit 1801 sets how much the luminance of the image as a whole is to be enhanced as a luminance target value L, in accordance with the degree of change in screen brightness B1. Luminance correction value calculating unit 1801 stores the given screen brightness B1, and determines how much the screen brightness has been changed. It is assumed that the target amount of change L of how much the luminance of the entire image is to be changed with respect to the degree of change in brightness is given beforehand to luminance correction value calculating unit 1801. Here luminance correction value calculating unit 1801 calculates a mean value of tone values of the entire image.

Thereafter, at step S2102, luminance correction value calculating unit 1801 selects the local maximum point Pᵢ of maximum value, based on the parameter PR1 applied from image feature extracting unit 1601.

By way of example, in the histogram shown in FIG. 20, P₃ is selected.

Next, at step S2104, luminance correction value calculating unit 1801 determines the range of tone on the higher tone side than the local maximum point selected at step S2102, to compress the tone range. Here, the tone value on the left end of the range to be compressed is represented by Xₐ, and the tone value on the right end of the range is represented by X_{c}, where Pᵢ<Xₐ and X_{c}<Pᵢ₊₁. If Pᵢ₊₁ does not exist, X_{H} is used instead. Alternatively, the maximum value Xmax of possible luminance may be used.

If a local minimum value Qⱼ exists between Xₐ and X_{c}, Xₐ may be a median between local maximum point Pᵢ and local minimum point Qⱼ (or any arbitrary internal dividing point) (if no local minimum point exists between Xₐ and X_{c}, a tone of which frequency is the smallest between Xₐ and X_{c} is used in place of the local minimum value). Alternatively, Xₐ may be determined such that frequency H(Xₐ) of Xₐ is at the median (or any arbitrary internal dividing point) between the frequency H(Pᵢ) of Pᵢ and the frequency H(Qⱼ) of Qⱼ. The same applies to X_{c}.

In connection with the histogram shown in FIG. 20, Xₐ and X_{c} will be specifically described with reference to FIG. 22(B). In the histogram, local maximum point P₃ is selected at step S2102. In FIG. 22(B), no local minimum point exists on the right side of P₃, and therefore, X_{c}=Xmax. Further, Xₐ is determined such that its frequency H(Xₐ) is at the median between frequencies H(P₃) and H(Xmax).

Returning to FIG. 21, at step S2106, luminance correction value calculating unit 1801 calculates the correction value by compressing tone between Xₐ and X_{c}, as described in relation to step S904. Here, in determining the width n after compression of width m between Xₐ and X_{c}, the following method may be used in place of the method described in connection with step S904.

The width m=X_{c}−Xₐ of the tone and the target amount of change L of luminance are compared. The width is determined such that if m<L/4, n=m, if L/4≦m≦L/2, n=m−L/4, if L/2≦m<L, n=m−L/2, and if L<m, n=m−L.

As shown in FIG. 12, by tone compression, the width Xₐ−X_{c} of tone is compressed to X_{b}−X_{c} and (m−n) tones are left unused. The input/output relation when the tone is thus compressed is as shown in FIG. 22(C). Here, when the histogram shown in FIG. 22(B) is used as an input, a histogram such as shown in FIG. 22D) is output, in accordance with the input/output relation shown in FIG. 22(C).

Returning to FIG. 21, at step S2108, luminance correction value calculating unit 1801 adds (m−n) to the tone value on the lower tone side than Xₐ to calculate the correction value, as described in connection with step S906.

Luminance correction value calculating unit 1801 outputs correction values for respective tone values provided by the process up to this step, in the form of the luminance conversion table.

The luminance conversion table so far is given as a graph in FIG. 22(E), where K=m−n.

When the histogram shown in FIG. 22(B) is given as an input and the input/output relation shown in FIG. 22(E) is applied, a histogram such as shown by the solid line of FIG. 22(F) results. The histogram of dotted line in FIG. 22(F) corresponds to the histogram of FIG. 22(B).

At step S2110, luminance correction value calculating unit 1801 calculates the mean value of tone values of the entire image when tone is corrected on the luminance component using the luminance conversion table. Here, the mean value of tone is calculated from the histogram after tone correction using the luminance conversion table calculated in the above-described manner.

At step S2112, luminance correction value calculating unit 1801 determines whether the difference between the mean value of tone of the image not subjected to the tone correction calculated at step S2100 and the mean value of tone of the image after tone correction calculated at step S2110 is smaller than the target amount of change of luminance.

If it is determined that the difference in mean value exceeds the target amount of change in luminance (NO at step S2112), the process proceeds to step S2114. Otherwise (YES at step S2112), the process returns to the step S2102, and steps S2102 to S2112 are executed repeatedly.

Finally, at step S2114, luminance correction value calculating unit 1801 executes a tone expansion process on a portion of low tone of luminance conversion table. This process is performed to prevent a phenomenon that dark portions in the image becomes more noticeable as the value of portions having low tone (luminance) increases while the luminance tone is corrected.

At step S2108 described above, (m−n) is uniformly added to the tone lower than the left end Xₐ of compressed tone. Therefore, if the input of tone correction is 0, the output will be (m−n). Eventually, however, the process of steps S2102 to S2112 is repeated, and therefore, if the input of tone correction is 0, the output will be K (where K≧m−n, K is a positive integer).

Assume, for example, that a tone value x in the range of 0 to X_{d} is input. The following equation (2) may be used, so that the output of 0 is provided when tone x is 0.

$${x}^{′} = ( 1 + \frac{G}{Xd} ) x \qquad ( 2 )$$

The value x′ calculated in accordance with Equation (2) will be the correction value of tone value x in the range of 0 to X_{d}.

Here, X_{d} may be a value of the smallest local minimum point of the histogram subjected to tone correction using the luminance conversion table, or it may be a mean value of tone values, or it may be a preset value.

When the tone expansion process of step S2114 is performed where the input/output relation shown in FIG. 22(E) holds, the result is as shown in FIG. 22(G).

When the histogram represented by the solid line of FIG. 22(F) is input and the input/output relation shown in FIG. 22(G) is applied, a histogram such as represented by the solid line of FIG. 22(H) is output. The histogram represented by the dotted line of FIG. 22(H) corresponds to the histogram of FIG. 22(F). It can be seen from FIG. 22(H) that the tone of X_{d} and lower is expanded, as compared with the histogram of FIG. 22(F).

In the foregoing, an example of tone compression using linear equation at step S2106 has been described. For tone compression, conversion based on second or higher order polynomial or other curve may be used. Equations (3) and (4) below represent conversion equations by quadric curve and cosine function to have the tone value x changed to corrected value x′.

$$\begin{matrix}\begin{matrix}{x}^{′} = - χ ( x - Xc ) ( x - 2 Xa + Xc ) \\ χ = \frac{1}{{( Xc - Xa )}^{2}}\end{matrix} \} & ( 3 ) \\ \begin{matrix}{x}^{′} = x - ( Xc - Xb ) ( cos θ - 1 ) \\ θ = π \cdot \frac{x - 2 Xa + Xc}{Xc - Xa}\end{matrix} \} & ( 4 )\end{matrix}$$

(Operation of Chrominance Correction Value Calculating Unit 1802)

Chrominance correction value calculating unit 1802 calculates a chrominance conversion table for correcting chrominance component (U, V) such that the degree of color density (density) increases in accordance with the amount of change in screen brightness.

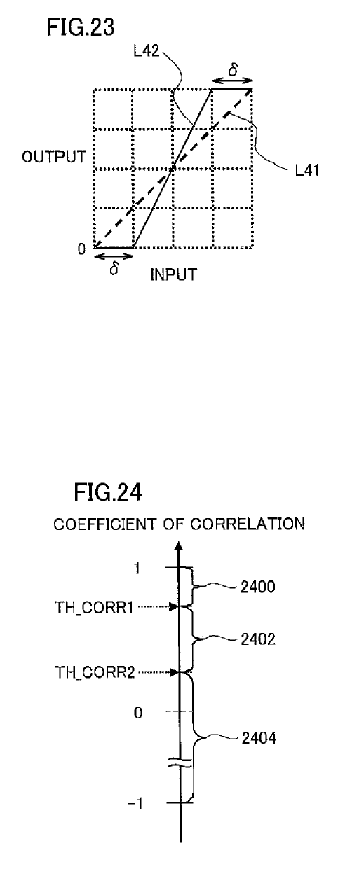

FIG. 23 shows an input/output relation corresponding to the chrominance conversion table.

Referring to FIG. 23, the input/output relation corresponding to the chrominance conversion table will be described. L41 represents the input/output relation when tone correction is not performed, and L42 represents the input/output relation when tone correction is performed, L42 provides the output of 0 if the input is from 0 to δ−1, and provides the output of 255 (in 256 tone) if the input is (256-6) to 255.

Chrominance correction value calculating unit 1802 determines the correction value such that δ becomes larger as the amount of change in brightness B1 of the screen increases. Chrominance correction value calculating unit 1802 stores the given brightness B1 of the screen, and determines how much the brightness of the screen has been changed. It is assumed that how much the value 6 is to be increased in accordance with the degree of change in brightness is determined in advance. The value 6 may be made larger when the target amount of change L of luminance set at step S2100 becomes larger, or the value δ may be made larger when the difference in mean value of luminance tone before and after tone correction calculated at step S2112 becomes larger. By way of example, if the value δ is determined in accordance with the target amount of change L of luminance, δ and L may be related to each other such as δ=L/2.

(Operation of Table Selecting Unit 1804)

Table selecting unit 1804 selects the luminance conversion table to be used for the tone correcting process, in accordance with the degree of correlation. Table selecting unit 1804 has a first threshold value TH_CORR1 and a second threshold value TH_CORR2 set in advance. The luminance conversion table is selected dependent on the relation with these threshold values. In the present embodiment, it is assumed that the second threshold value is smaller than the first threshold value.

As will be described in the following, if the degree of correlation between the current frame and the previous frame is high, table selecting unit 1804 selects the conversion table for the previous frame as the conversion table for the current frame. If the degree of correlation is within a prescribe range (in the present embodiment, between the first and second threshold values), weighted mean of these conversion tables is selected as the conversion table.

FIG. 24 shows a correspondence between the correlation coefficient and the selected luminance conversion table.

Referring to FIG. 24, the correspondence between the correlation coefficient and the selected luminance conversion table will be described.

If it is determined that the coefficient of correlation R is in section 2400 (TH_CORR1≦R≦1), table selecting unit 1804 reads the luminance conversion table of the previous frame from conversion table memory 1805 for the previous frame.

If it is determined that the coefficient of correlation R is in section 2402 (TH_CORR2≦R<TH_CORR1), table selecting unit 1804 reads the luminance conversion table for the current frame from conversion table memory 1803 for the current frame and reads the luminance conversion table of the previous frame from a conversion table memory 1805 for the previous frame, respectively. Then, by calculating a weighted mean of these, a new luminance conversion table is determined.

Here, let us represent the correction value of the conversion table for the current frame as Curr[k], and the correction value of the conversion table for the previous frame as Prev[k]. Then, the correction value of the new conversion table New[k] is calculated as New[k]=w1·Prev[k]+w2·Curr[k]. Here, w1 and w2 are weight coefficients (0<w1, w2<1), and k is a natural number. By way of example, w1 and w2 may be determined such that w1=10·(R−TH_CORR2), w2=1−w1.

Further, if it is determined that the coefficient of correlation R is in section 2404 (−1≦R<TH_CORR2), table selecting unit 1804 reads the luminance conversion table for the current frame from conversion table memory 1803 for the current frame.

The luminance conversion table selected by table selecting unit 1804 is applied to conversion table memory 1805 for the previous frame, and saved.

Next, the operation of correcting unit 1603 will be described.

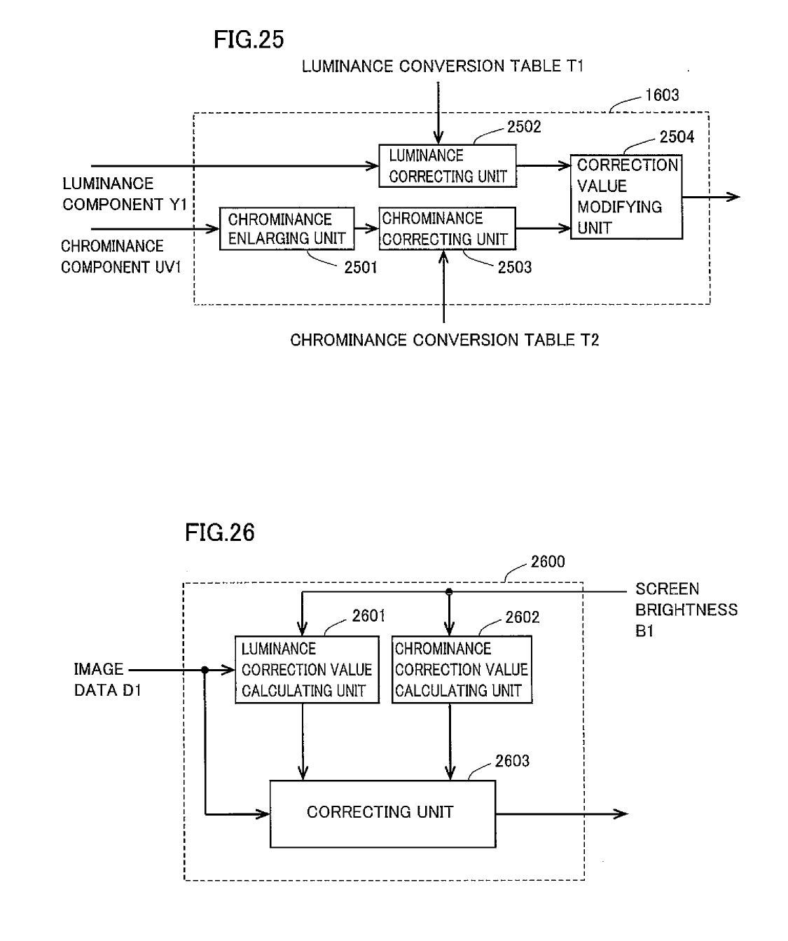

FIG. 25 is a block diagram showing an exemplary configuration of correcting unit 1603.

Referring to FIG. 25, the configuration of correcting unit 1603 will be described.

Correcting unit 1603 includes a chrominance enlarging unit 2501 up-sampling chrominance component of an image, a luminance correcting unit 2502 correcting tone of luminance component of the image, a chrominance correcting unit 2503 correcting chrominance component of the image, and a correction modifying unit 2504 modifying the tone values of chrominance and luminance as corrected. The input image data is divided into luminance component Y1 and chrominance components U1 and V1 (hereinafter referred to as “UV1”), and input to luminance correcting unit 2502 and chrominance enlarging unit 2501, respectively.

Chrominance enlarging unit 2501 up-samples the chrominance component UV1 as needed. Generally, the human visual sensitivity to the chrominance component is lower than that to luminance component and, therefore, it is sometimes subjected to down-sampling, to reduce amount of information. By way of example, in a general coding process, a 4:2:0 format is used. In 4:2:0 format, the chrominance component is down-sampled both in the horizontal and vertical directions, to have the size ½ times the luminance component. Chrominance enlarging unit 2501 has a function of up-sampling the chrominance component to have the same size as the luminance component.

Luminance correcting unit 2502 refers to the luminance conversion table T1 calculated by correction value calculating unit 1602, and outputs a correction value Y2 corresponding to the input luminance component Y1.

Chrominance correcting unit 2503 refers to chrominance conversion table T2 calculated by correction value calculating unit 1602, and outputs a correction value UV2 corresponding to the input chrominance component UV1.

Correction value modifying unit 2504 modifies the luminance correction value Y2. This is to prevent overflow of R, G and B values when the YUV format is converted to the RGB format after luminance component Y1 is corrected by luminance correcting unit 2502.

First, correction value modifying unit 2504 calculates R, G and B from luminance correction value Y2 and chrominance correction value UV2 corrected after up-sampling. If the highest value among R, G and B exceeds an upper limit it may assume, the exceeded amount is subtracted from Y2, and the result is used as a modified correction value Y3.

For instance, when R>G>B, the value R becomes the highest. When we represent the highest possible value, that is, the upper limit of R by Rmax, an amount corresponding to R−Rmax is subtracted from Y2, only if R−Rmax>0.

Correction value modifying unit 2504 further modifies the correction value UV2 of chrominance component UV2. This is to prevent change in seeming color shade resulting from change in chroma saturation when the luminance tone is increased by the correction, when expression in hue, chroma saturation and intensity is considered, focusing on the pixel colors.

Correction value modifying unit 2504 calculates chroma C1 of the image before luminance correction, from color component correction value UV2 and luminance component Y1 before correction. Next, it calculates chroma C2 after luminance correction, from color component correction value UV2 and luminance correction value Y3 after luminance correction.

Correction value modifying unit 2504 modifies the chroma C2 after the correction of luminance component such that it comes closer to chroma C1 before the correction of luminance component. Thus, chroma C3 results. For instance, if C2>C1, C3=C2−ΔC, and if C2<C1, C3=C2+ΔC. Here, ΔC represents the amount of chroma modification, which is determined in accordance with the values of C1 and C2 as well as the color system. By way of example, ΔC may be ΔC=C2−C1. Thereafter, luminance modification value Y4 and chrominance modification value UV3 are calculated from chroma C3.

Correction value modifying unit 2504 outputs image data of YUV format, which has been subjected to the correction and modification processes as described above, to display unit 30. Alternatively, as the values R, G and B can be calculated using modified chroma C3, an image data in RGB format may be output to display unit 30.

The manner of expression in hue, chroma saturation and brightness is not specifically limited. By way of example, a hexagonal pyramid model or a hexagonal bipyramid model in which the relation between RGB and HIS is approximated to a linear correspondence may be used. Further, L*a*b color system, L*C*h color system, Yxy color system or the like may be used.

In the foregoing description, the color component is corrected and thereafter, the corrected chrominance component is modified. It may be possible to modify the chrominance component based on chroma, and thereafter, the chrominance component may be corrected. In that case, from the chrominance component UV1 and luminance component Y1 before correction, chroma 1 before correction is calculated, and from chrominance component UV1 and correction value Y2 of luminance, corrected chroma C2 is calculated. Thereafter, C3 is calculated in the similar manner as described above. Then, luminance modification value Y5 and chrominance modification value UV4 may be calculated using C3.

As described above, in the tone correcting apparatus in accordance with the present embodiment, the characteristic related to the tone of moving image is extracted as image feature, and the correction value to be used for the correcting process is calculated based on the feature. Therefore, an adaptive tone correction is realized. Further, the correction value is modified to lessen variation of color shade, based on pixel color. Therefore, even when the screen brightness is made darker, easiness of viewing the image can be improved without unnatural correction.

### EMBODIMENT 5

In Embodiment 5, an example of tone correcting apparatus for performing tone correction, incorporated in a moving image playback apparatus, different from Embodiment 4 will be proposed. In the following, the tone correcting apparatus in accordance with the present embodiment is described as incorporated in a moving image playback apparatus in place of the tone correcting apparatus in accordance with Embodiment 4.

FIG. 26 is a block diagram representing an exemplary configuration of a tone correcting apparatus 2600.

Referring to FIG. 26, the configuration of tone correcting apparatus 2600 will be described.

Tone correcting apparatus 2600 includes a luminance correction value calculating unit 2601, a chrominance correction value calculating unit 2602, and a correcting unit 2603.

Luminance correction value calculating unit 2601 calculates a correction value of the luminance component of input image data D1, in accordance with the change in brightness B1 of the screen. As to the method of calculating luminance correction value, the correction value may be calculated based on the characteristic related to tone of luminance component extracted as the image feature as described in Embodiment 4 above, or it may be calculated using a relation between the screen brightness and the correction value determined in advance, or other method may be used.

Chrominance correction value calculating unit 2602 calculates a correction value for the chrominance component of the image data in accordance with the change in brightness B1 of the screen as described with reference to Embodiment 4 above.

Correcting unit 2603 corrects the image data (YUV format) using the luminance correction value input from luminance correction value calculating unit 2601 and the chrominance correction value input from chrominance correction value calculating unit 2602. The configuration and operation of correcting unit 2603 are the same as those of correcting unit 1603 described in Embodiment 4.

As described above, the luminance component of the image is corrected and the chrominance component is also corrected, in accordance with the change in brightness when the screen is made darker. Therefore, without unnatural correction, easiness of viewing the image can be improved.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

1-12. (canceled)

13. A moving image playback apparatus, comprising:
a display unit for displaying an image;
a display control unit for controlling brightness of a screen at said display unit; and
a tone adjusting unit for adjusting tone of an input image in correspondence with said brightness of the screen applied from said display control unit; wherein
said display control unit controls said tone adjusting unit such that when said brightness of the screen is regulated to be darker than a prescribed brightness, an image adjusted by said tone adjusting unit is displayed on said display unit; and
said tone adjusting unit includes
an image feature extracting unit extracting a characteristic related to tone of said input image, as an image feature,
a correction value calculating unit calculating a correction value for a tone value of the image based on said image feature and on a change in said brightness of the screen, and
a correcting unit correcting the tone of said input image, using said correction value.

14. The moving image playback apparatus according to claim 13, wherein
said correction value calculating unit calculates such a correction value that, among pixels of said input image, the number of pixels of which tone saturates by the correction does not exceed a prescribed value, when frequencies of pixel intensities of said image are distributed within a prescribed range in relation to said characteristic related to tone of said image, and
calculates such a correction value that tone in a range satisfying a prescribed condition is compressed, when frequencies of pixel intensities of said image are distributed out of a prescribed range in relation to said characteristic related to tone of said image.

15. The moving image playback apparatus according to claim 14, wherein
said tone adjusting unit includes switching means for selecting and applying to said display unit either the image corrected by said correcting unit or said input image; and
said display control unit controls said switching means such that when said brightness of the screen is regulated to be darker than a prescribed brightness, an image corrected by said correcting unit is applied to said display unit.

16. The moving image playback apparatus according to claim 13, wherein
said correction value calculating unit includes means for calculating a correlation value between continuous, previous and succeeding frames of an input moving image and for outputting, when correlation of histogram is high, a correction value for said preceding frame.

17. The moving image playback apparatus according to claim 13, wherein
said input image consists of luminance component and chrominance component; and
said correction value calculating unit includes means for changing a correction value for said luminance component in accordance with histogram distribution of said chrominance component.

18. The moving image playback apparatus according to claim 13, further comprising
a filtering unit for enhancing sharpness of the input image, as said brightness of the screen applied from said display control unit becomes darker.

19. A tone correcting apparatus for correcting tone of a moving image to be displayed on a display apparatus, comprising
an image feature extracting unit extracting a characteristic related to tone of an image as one frame of said moving image as an image feature;
a frame correlation calculating unit calculating degree of correlation between frames preceding and succeeding in time;
a correction value calculating unit calculating a correction value for the tone of said image, based on said image feature, a change in brightness of a screen of said display apparatus and said degree of correlation between frames; and
a correcting unit correcting tone of said image using said correction value.

20. The tone correcting apparatus according to claim 19, wherein
said image consists of luminance component and chrominance component; and
said correction value calculating unit includes
a luminance correction value calculating unit calculating a first luminance correction value for said luminance component of a first frame as an object of correction, based on said image feature, in accordance with a change in said brightness of the screen,
a chrominance correction value calculating unit calculating a chrominance correction value for said chrominance component of said first frame in accordance with the change in said brightness of the screen,
a memory unit storing a second correction value for said luminance component of a second frame preceding in time to said first frame, and
a correction value selecting unit selecting any one of said first luminance correction value, said second luminance correction value, and a weighted mean correction value obtained as weighted mean of said first luminance correction value and said second luminance correction value in accordance with degree of correlation between said first frame and said second frame, and applying it to said correcting unit.

21. The tone correcting apparatus according to claim 20, wherein
said correction value selecting unit selects
said weighted mean correction value in response to a determination that said degree of correlation is in a prescribed range,
said first correction value in response to a determination that said degree of correlation is larger than said prescribed range, and
said second correction value in response to a determination that said degree of correlation is smaller than said prescribed range.

22. The tone correcting apparatus according to claim 19, wherein
said image consists of luminance component and chrominance component; and
said correcting unit includes
a luminance correcting unit correcting said luminance component of said image using a luminance correction value for said luminance component,
a chrominance correcting unit correcting said chrominance component of said image using a chrominance correction value for said chrominance component, and
a correction value modifying unit modifying said luminance correction value such that each value of three primary color signals calculated from said luminance correction value and said chrominance correction value does not exceed a prescribed value, and modifying said chrominance correction value based on chroma of said image.

23. The tone correcting apparatus according to claim 19, wherein
said image consists of luminance component and chrominance component; and
said correcting unit includes
a luminance correcting unit correcting said luminance component of said image using a luminance correction value for said luminance component,
a chrominance correcting unit correcting said chrominance component of said image using a chrominance correction value for said chrominance component, and
a chrominance modifying unit modifying said chrominance component such that a first chroma calculated from said luminance correction value and said chrominance component comes closer to a second chroma calculated from said luminance component and said chrominance component.
